(19) United States
(12) Patent Application Publication
(10) Pub. No.: US 2003/0004872 A1
(43) Pub. Date: Jan. 2, 2003

(54) Electronic direct marketing

(76) Inventors: Michael E. Gardi, Waterloo (CA); Adrian Michael Toohey, Waterloo, CA (US); Kenneth William Outcalt, Ann Arbor, MI (US)

Correspondence Address: LALOS & KEEGAN, Fifth Floor, 1146 Nineteenth Street, N.W., Washington, DC, 20036, US

(21) Appl. No.: 09/893,597

(22) Filed: Jun. 29, 2001

(51) Int. Cl. G06F 17/60; H04K 1/00; H04L 9/00

(52) U.S. Cl. 705/40

(57) ABSTRACT

The present invention provides a method, system, and article of manufacture for presenting customer-specific supplemental information with billing information. Billing information is received. A decision is made if the customer qualifies to receive an item of supplemental information. This decision is based upon attributes and characteristics of the customer. If the customer qualifies to receive the supplemental information, a bill is produced having both billing information and the supplemental information. If the customer does not qualify, a bill is produced which does not have that supplemental information.

### TECHNICAL FIELD

The present invention relates generally to electronic bill or statement presentment and more particularly to targeted presentation of supplemental information with an electronic bill or statement.

### BACKGROUND ART

Billers have traditionally presented bills and statements to their customers in paper form. With the advent of affordable computers and widespread network access, bill and statement presentment has migrated from paper presentment to electronic presentment. Electronic presentment is achieved by various methods. For example, some bills and statements are presented via e-mail, some are presented via the World Wide Web, some are presented via private network links between billers and customers, and some are presented via telephone or other communications devices. No matter the electronic method by which a bill or statement is presented, it will be understood that information indicating an amount owed is transmitted to a customer's computing and/or communication device in electronic presentment.

Electronic bills and statements are not only presented by billers themselves, but also by bill presentment service providers. Bill presentment service providers obtain billing information from billers and in turn electronically present bills and statements to customers of the billers. This billing information can be obtained directly from a biller's computer system by a bill presentment service provider, or it can be obtained from a paper copy of a bill or statement that have been previously generated by a biller's computer system. Electronic bills and statements that are presented by billers are often said to be presented via a biller-direct system. Electronic bills and statements that are presented by bill presentment service providers are often said to be presented via a bill aggregation system. There are also hybrid electronic bill presentment systems in which a portion of a bill or statement is electronically presented by a biller and another portion of the same bill or statement is electronically presented by a bill presentment service provider. Typically, in a hybrid system, summary bill information, such as an amount owed, is presented by a bill presentment service provider, while bill detail, such as line item charges and supplemental information, is presented by a biller. Such systems allow the biller to maintain control of the bill presentation experience.

In conventional paper presentment, billers often present supplemental information in addition to billing information. Presentment of supplemental information is either in the form of paper inserts, known as envelope stuffers, included with a bill or statement, or printed directly upon a bill or statement. Supplemental information is typically an advertisement or promotional offer, known as an up-sell. Likewise, bills and statements presented electronically often include supplemental information. In electronic presentment of supplemental information, the supplemental information can be presented along with billing information, or can be presented separately from the billing information. That is, when the supplemental information is presented along with the billing information, a customer viewing a bill or statement views the supplemental information at the same time as viewing billing information, much like supplemental information printed on bills. When the supplemental information is presented separately from billing information, at least two presentment methods are used. In a first, a link to supplemental information is included in the presentment of billing information. In a second, the supplemental information is presented via an independent presentation triggered by presentation of billing information. For example, supplemental information can be delivered via a pop-up ad, or even via an e-mail message transmitted to a customer at the same time billing information is transmitted to a customer. Supplemental information, whether presented on paper or electronically, can be general information for all customers receiving a bill or statement, or can be targeted information for only specific customers. When the supplemental information is targeted information, whether presented electronically or presented via paper, only specific, targeted customers are selected to receive the supplemental information. A selection of those customers to receive the targeted supplemental information is made by a biller.

Various billing systems are disclosed in the prior art for presenting targeted supplemental information. According to one such system, selection of those customers to receive targeted supplemental information is based upon the bill or statement itself. That is, receipt of targeted supplemental information is dependent upon purchases made and charges incurred in the last billing cycle. In other words, the bill or statement content controls delivery of supplemental targeted information. Another system of presenting targeted supplemental information relies upon historical billing data. That is, purchases and charges incurred prior to, and perhaps including, the latest billing cycle control selection of those customers to receive targeted supplemental information. Yet another billing system for presenting targeted supplemental information relies upon a customer's credit limit. In this system, the supplemental information is a purchase offer. The targeted purchase offer is only presented to those customers that have available credit to make the offered purchase. Similar to presenting targeted supplemental information based upon a customer's credit limit, targeted supplemental information is also presented based upon a customer's credit rating. That is, supplemental information is only presented to those customers who possess a given credit rating. All of these techniques are equally applicable to both paper billing and electronic billing.

Many businesses compile information concerning their customer base. This information is used as a factor in formulating business plans and strategies. This customer information is gathered from many sources. The sources includes a business' own records, governmental records, polls, academic studies, and information compiled by businesses specializing in gathering such information. The information includes such things as information indicating a customer's behavior with the business, as well as with other businesses and organizations. This can include a customer's buying habits as well as other behaviors. For example, information can indicate whether a given customer makes catalogue purchases, whether a given customer frequents multiple locations of a given business, the location of a business a given customer most often frequents, whether a given customer utilizes automated features of one or more businesses, such as Web or telephone services, magazine subscriptions held by a customer, and pay-per-view purchases made by a customer, among possible types of behavioral information that can be gathered. The information also includes demographic and geographic information. For example, a customer's credit rating, age, income, education level, marital status, membership in social, professional, and other organizations, and location of residence, are examples of information gathered on customers. It will be appreciated that the types of customer information and examples of customer information cited herein are but a small portion of the myriad of types of information typically gathered on customers.

While the above-discussed billing systems select recipients of targeted supplemental information based upon billing or credit information, no known bill or statement presentment system selects recipients based upon compiled customer base information. This customer base information is useful to identify those customers who are most likely to respond to presented supplemental information. Accordingly, a need exists for a technique of bill or statement presentation in which recipients of targeted supplemental information are selected based upon compiled customer base information other than current or historical bill content, credit limits, or credit ratings.

Sophisticated systems have been developed to gather and manipulate customer base information. These systems are known as customer relationship management (CRM) systems. These sophisticated CRM systems store information associated with customers such that a business can identify any subset and combination of customers which possess common characteristics. CRM customer information is constantly updated and added to so that a business has the most accurate picture possible of its customer base. CRM customer information includes any type of information gathered by businesses. While some CRM systems store historical billing information and credit information, there is currently no known technique for combining a CRM system with a billing system to present targeted supplemental information. Accordingly, a need exists for a technique to leverage a CRM system in selecting those customers who are to receive targeted supplemental information along with a bill or statement.

### OBJECTIVES OF THE INVENTION

Accordingly, it is an objective of the present invention to provide a technique to select customers to receive targeted supplemental information based upon information other than current or historical billing information or credit information.

It is also an objective of the present invention to provide a technique to link a CRM system with a billing system to select those customers who are to receive targeted supplemental information.

Additional objects, advantages, novel features of the present invention will become apparent to those skilled in the art from this disclosure, including the following detailed description, as well as by practice of the invention. While the invention is described below with reference to preferred embodiment(s), it should be understood that the invention is not limited thereto. Those of ordinary skill in the art having access to the teachings herein will recognize additional implementations, modifications, and embodiments, as well as other fields of use, which are within the scope of the invention as disclosed and claimed herein and with respect to which the invention could be of significant utility.

### SUMMARY DISCLOSURE OF THE INVENTION

The present invention provides techniques for presenting customer-specific supplemental information with billing information. Methods, systems and an article of manufacture are provided for implementing embodiments of the present invention. Supplemental information can be any type of information directed to a customer along with billing information. Customer-specific supplemental information is information specifically directed to a given customer or group of customers having certain characteristics or attributes. That is, not all customers receive the customer-specific supplemental information. In accordance with the present invention, only those customers having defined attributes and/or characteristics are presented the customer-specific supplemental information. The determination of what those characteristics and/or attributes are, and what supplemental information is presented, can be determined by a biller, or by an entity other than a biller.

The embodiments described herein can be practiced by billers that generate and present their own bills, can be practiced by bill aggregators that generate and present bills on behalf of billers, and can be practiced by bill aggregators that only present bills on behalf of billers. Likewise, the systems described herein can be operated by billers and by bill aggregators alike. And the article of manufacture described herein can also be utilized by both billers and bill aggregators. Furthermore, the methods, systems, and article of manufacture can each be used to present bills via traditional paper presentment, or via electronic presentment.

In accordance with each embodiment, billing information associated with a customer is received. If a biller is practicing a method, the billing information could be received from any type legacy billing system or billing information storage device. Billing information is information upon which a bill presented to a customer is based. If a bill aggregator is practicing a method, the billing information is received from a biller. Billing information received from a biller by a bill aggregator could be summary bill information, or detailed bill information. Additionally, billing information received from a biller could be received in the form of a bill generated by the biller. Further, the received billing information, whether received by a biller or by a bill aggregator could be formatted for presentation, partially formatted for presentation, or unformatted for presentation.

According to a first embodiment, a determination is made as to whether the customer qualifies for presentment of a supplemental information item. This supplemental information item could be any type of supplemental information which can be presented to a customer with billing information. The determination is made based upon qualification information other than the received billing information, historical billing information associated with the customer, or credit information associated with the customer. That is, billing information associated with a present or a past billing cycle is not used to determine if the customer qualifies for presentment of this supplemental information item. Also, a customer's credit history, credit rating, or credit availability is not used to determine if the customer qualifies for presentment of this supplemental information item. Introduced above, selection of qualification information and selection of supplemental information associated with that qualification information can be made by a biller, or can be made by another entity. This is equally applicable in situations in which either a biller or a bill aggregator practices the inventive technique. For example, these selections could be made by the biller when the biller practices the invention, or when a bill aggregator presenting bills on behalf of the biller practices the invention. Also for example, a biller could allow another to purchase the right to include supplemental information in bills associated with that biller. Or for example, a bill aggregator could sell rights, preferably with the biller's consent, to entities other than the biller to include supplemental information presented on behalf of the biller. Also, the bill aggregator could make the decision as to what, and according to what qualification information, supplemental information item is presented.

If the determination is that the customer qualifies for presentment of the supplemental information item, a bill presentation is generated including both the received billing information and the supplemental information item. The generated bill presentation could be a paper bill having at least a part of the received billing information and the supplemental information item printed thereon. Also, the generated bill presentation could be a first sheet of paper having at least a part of the billing information printed thereon, and a second sheet of paper having the supplemental information item printed thereon. The generated bill presentation could be an electronic bill including at least a part of the received billing information and the supplemental information item. Or, a generated electronic bill presentation could include at least a part of the received billing information and a link to access the supplemental information item. A generated electronic bill presentation could be presented to the customer via e-mail, via the World Wide Web, or via some other messaging protocol and via any type network.

If the determination is that the customer does not qualify for presentment of the supplemental information item, the generated bill presentation includes only the received billing information. This bill presentation, as above, could be paper or electronic. Also, even though the customer does not qualify for presentation of the supplemental information item, another, general, supplemental information item presented to all customers could be included in the generated bill presentation.

The generated bill presentation is presented to the customer. As introduced above, this could be presentation via paper, or presentation via electronic means.

According to one aspect of the present invention, the supplemental information item is one of an advertisement, an upsell offer, or a cross-sell offer. An upsell offer is an offer of a product or service having more value than another product or service. The other is a product a customer already possesses, and the other service is a service a customer already utilizes. A cross-sell offer is an offer of a product or service related to a product a customer already possesses, or a service a customer already utilizes. The possessed product may or may not be a product sold to the customer by an entity making the cross-sell offer. Likewise, the utilized service may or may not be a service provided by the entity making the cross-sell offer to the customer.

According to another especially beneficial and advantageous aspect of the invention, the determination of customer qualification for presentment of the supplemental information item is based upon at least one of, or both, the customer's relationship with the biller, and the customer's prior behavior. That is, targeted, customer-specific supplemental information can be presented to those customers having a certain type relationship with the biller. Also, targeted, customer-specific supplemental information can be presented to those customers having behaved a certain way in the past. Both a customer-biller relationship and past customer behavior are indicators of potential customer response to a given supplemental information item. In this manner, supplemental information can be presented to only those customers to whom that supplemental information may be valuable or interesting.

According to yet another aspect of the present invention, the determination of whether the customer qualifies for presentment of the supplemental information item is made in conjunction with a customer relationship management system. Customer relationship management systems collect, process, and store information associated with customers. This customer relationship management (CRM) system could be associated with the biller, or could be associated with another entity. When the determination is made in conjunction with a CRM system, a request is transmitted to the CRM system to determine if the customer qualifies. A response is received from the CRM system indicating either that the customer qualifies for presentment or does not qualify for presentment. That is, the CRM system determines if the customer is associated with the qualification information. The request could include information indicating qualification information, which is the criteria and/or characteristics which the customer must possess to qualify for presentation of the supplemental information item, and information identifying the customer. Or, only information identifying the customer could be included in the request. In such a situation, the information could be possessed by the CRM system, or the CRM system could obtain such information elsewhere.

According to another advantageous aspect of the present invention, customer response to presented supplemental information is tracked. Based upon customer response, qualification information can be modified. That is, the characteristics and/or criteria can be changed, eliminated, or added to. According to this aspect, customer response is received. This may be by a biller or by another entity. Based upon customer response, the qualification information is modified. Billing information associated wit a second customer is received. The determination as to whether that second customer qualifies for presentment, based upon the modified qualification information, is made. This determination is as described above. Also as described above, if the second customer qualifies, that customer is presented the supplemental information item. And also as above, if the second customer does not qualify, only the billing information is presented.

According to a second embodiment, multiple supplemental items exist for which the customer could qualify. Each of the multiple supplemental information items could be supplemental information items presented on behalf of the same entity, which may or may not be the biller, or one or more of the multiple supplemental information items could be presented on behalf of a different entity than the other multiple supplemental information items. A determination is made as to whether the customer qualifies for two or more of the supplemental information items. These determination could be made at the same time or at different times. Each of the determinations could be based upon the same qualification information, or could be based upon different qualification information. If it is determined that the customer qualifies for only one of the supplemental information items, that one supplemental information item is included in the generated bill presentation.

According to one aspect of this embodiment, if the customer qualifies for presentment of two instances of supplemental information items, only one of the items is included in the generated bill presentment based upon a prioritization. Each of these two supplemental information items has a priority relative to the other supplemental information items. This priority could be determined by the entity with which one or more of the items is associated, or could be made by another entity. The supplemental information item having the highest priority is included in the generated bill presentation.

According to yet another aspect of this embodiment, each of the supplemental information items for which the customer qualifies is included in the generated bill presentation.

According to another advantageous aspect of this embodiment, if the customer qualifies for presentment of two supplemental information items, a determination is made as to whether the two supplemental information items can be presented together. If so, the generated bill presentment includes the received billing information and each of the two supplemental information items. If two supplemental information items cannot be presented together, the supplemental information item having the highest priority is included in the generated bill presentment

According to a further aspect, the determination as to whether multiple supplemental information items can be presented together is based upon one or more of the following factors. A first factor is the availability of space to present multiple supplemental information items. As a generated bill presentation has a limited amount of space, a determination as to whether any more space exists for presentment of additional supplemental information items is made. A second factor is information indicating whether a respective one of the multiple supplemental information items with another supplemental information item. This determination could be made by the entity with which that supplemental information item is associated, or could be made by another. An entity may wish that no other supplemental information be presented at the same time as a certain supplemental information item. Or, an entity may not wish to present certain types of supplemental information with certain other types of supplemental information.

The systems to implement the inventive techniques each include a first processor and a second processor. Each of these processors could be any type of processor capable of functioning as described herein. The first processor is associated with a biller. The second processor could be associated with the biller, or could be associated with a bill aggregator or other entity presenting bills on behalf of a biller. The first processor is configured to transmit the billing information to the second processor. The second processor is configured to receive the billing information and perform the qualification determinations discussed above. The second processor is also configured to generate and present the bill presentment, as discussed above. According to one aspect of the invention, the system also includes a customer relationship management processor. The customer relationship management processor could be associated with a biller, or could be associated with another entity.

It will be understood by those skilled in the art that the inventive techniques are easily implemented using computer software. More particularly, software can be easily programmed, using routine programming skill, based upon the description of the invention set forth herein and stored on a storage medium which is readable by a computer processor to cause the processor to operate such that the techniques described herein are performed.

### BRIEF DESCRIPTION OF DRAWINGS

FIG. 1 is a schematic diagram of a billing system, a customer relationship management system, a printer, and, optionally, a communication interface, in accordance with a first embodiment of the present invention.

FIG. 2 is a further depiction of the billing system of FIG. 1.

FIGS. 3A and 3B are simplified flow diagrams depicting the operations to determine presentment of one or more supplemental information items in accordance with the first embodiment of the present invention.

FIG. 4 is a schematic diagram of a customer station, an electronic bill and statement presentment server, a billing system, and a customer relationship management system in accordance with a second embodiment of the present invention.

FIGS. 5A and 5B are simplified flow diagrams depicting the operations to determine presentment of one or more supplemental information items in accordance with the second embodiment of the present invention.

### BEST MODE FOR CARRYING OUT THE INVENTION

Unlike billing systems which target customers for receipt of supplemental information based solely upon financial factors, such as billing history and credit criteria, the methods and systems of the present invention provide automated techniques for billers and others to target customers based upon any information they maintain or have access to about customers. Especially advantageous, the present invention leverages a vast array of information maintained by sophisticated customer relationship management systems to unlock a previously unavailable resource. Customer relationship management data defines not only a customer's behavior, but also the customer's relationship with the biller or other entities. Utilizing CRM data, those customers most likely to respond to certain supplemental information can be specifically targeted for receipt of that information.

First Embodiment:

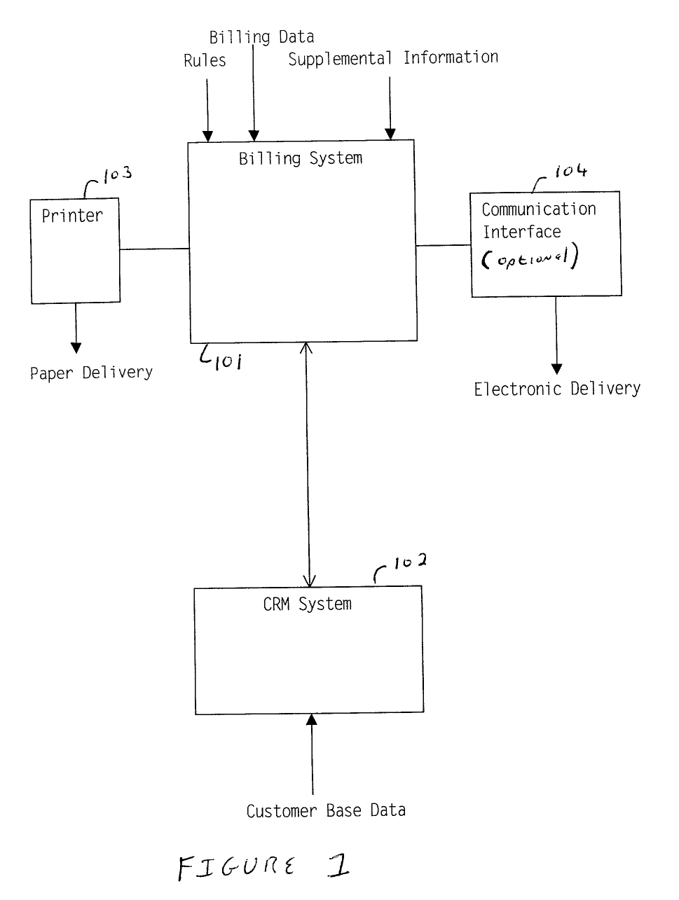

Referring to FIG. 1, shown is a billing system 101 in communication with a CRM system 102, a printer 103, and, optionally, a communication interface 104. The CRM system 102 can be any conventional CRM system, as described above. The printer 103 can also be any conventional printer capable of printing bills, statements, and supplemental information. Likewise, the communication interface 104 can be any conventional communication interface capable of electronically presenting bills, statements, and supplemental information. The billing system operates in accordance with the present invention to select customers to receive targeted supplemental information and to select which targeted supplemental information customers receive.

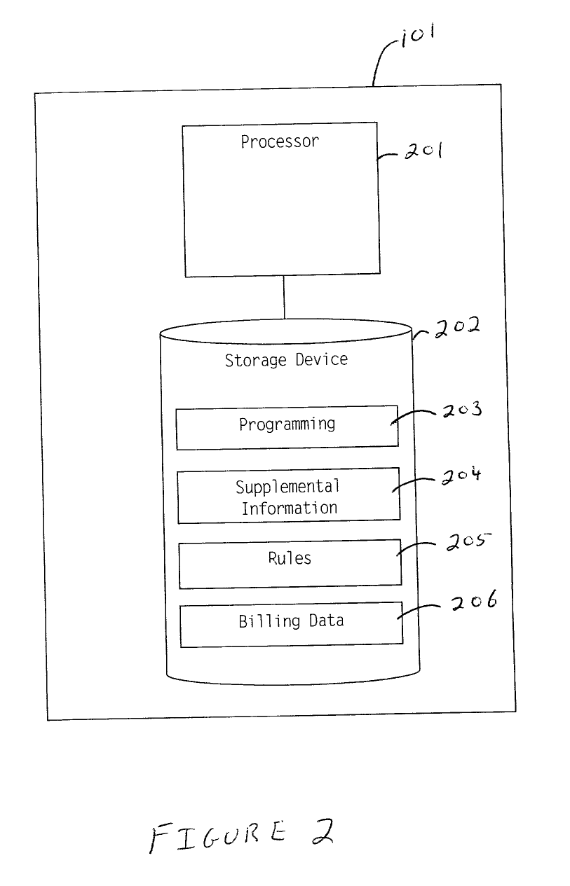

Referring to FIG. 2, shown is the billing system 101 in somewhat more detail than in FIG. 1. The billing system 101 includes a processor 201 and a storage device 202. The processor can be any type processor capable of operating as described herein. The storage device 202 can be any type storage device capable of storing information. The storage device 202 is configured to store the programming 203 necessary for functioning of the billing system, The storage device 202 is also configured to store a database of supplemental information 204, rules 205 for presenting supplemental information, and billing data 206. The supplemental information 204, rules 205, and billing data 206 are each input into the billing system 101 by a biller operating the billing system.

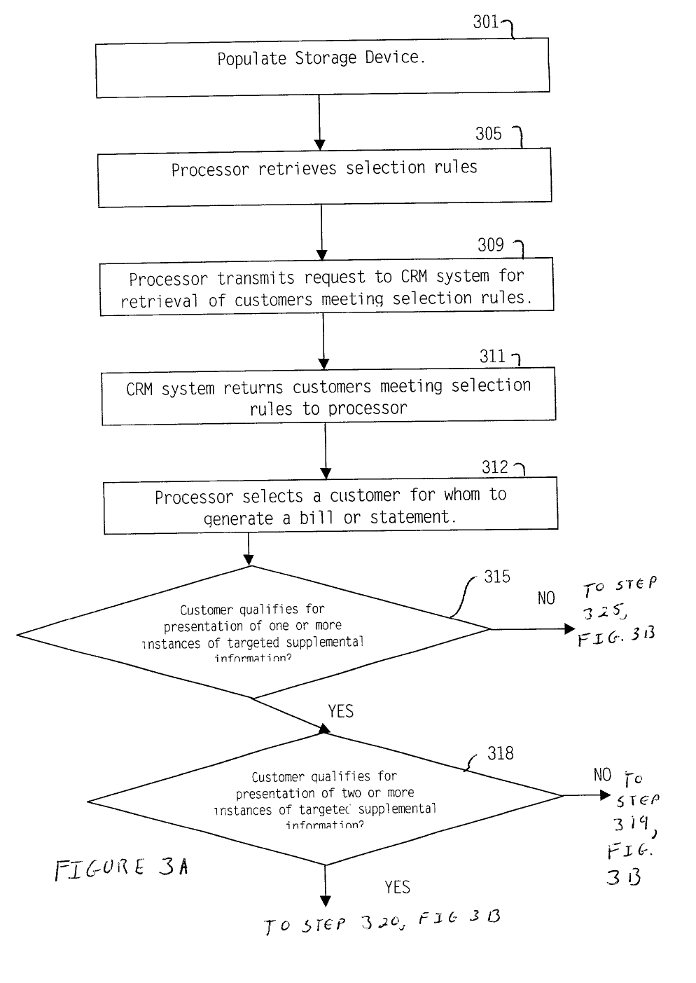

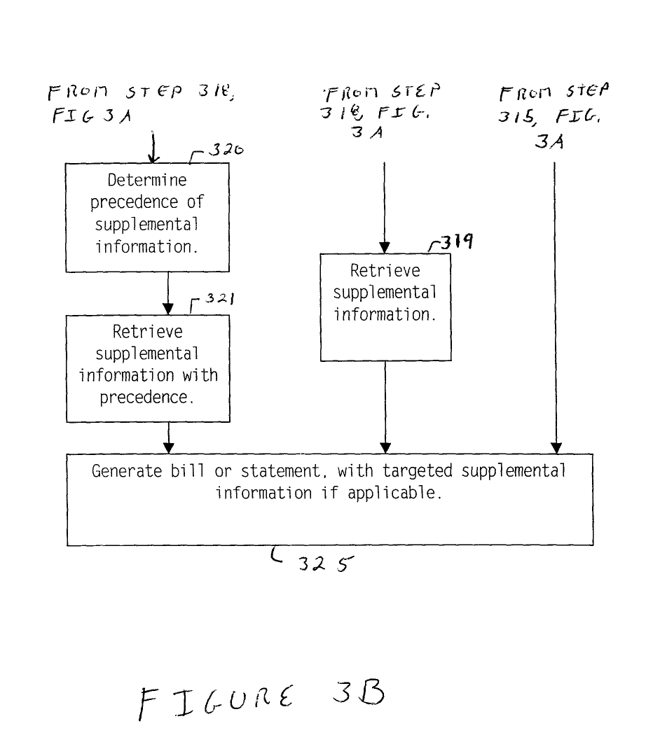

FIGS. 3A and 3B depict the operations to prepare and present targeted supplemental information and billing information in accordance with the present invention. At step 301, the storage device 202 is populated with information. This includes supplemental information 204, billing data 206, and selection rules 205. This input could take place at the same time for each of these three types of information, or each could be input at a different time. Furthermore, the rules and supplemental information can be changed periodically. Likewise, billing data is updated for each billing cycle.

At step 305 the processor 201 retrieves the selection rules from the storage device 202. A selection rule defines criteria for receiving targeted supplemental information. Each selection rule defines criteria for receiving particular targeted supplemental information item. Thus, a given customer could qualify, based upon selection rules, to receive multiple items of targeted supplemental information, each item being different from another item. Each item is targeted to those customers fitting a profile determined by the biller. A selection rule could include just one, or multiple qualification factors. For example, a first selection rule could require that only customers identified as frequenting a given location of a business be provided first targeted supplemental information. A second selection rule could require that only customers identified as both owning a home and utilizing a business' Web site be presented second targeted information different than the first targeted information. A third selection rule could require that only those customers that have contacted a business' customer care department between certain hours of the day and work in a given profession be presented third targeted information different than the first and second targeted information. It should be understood that any information a biller knows or maintains about customers could be used as criteria.

At step 309, the processor 201 transmits a query to the CRM system 102 to provide information identifying those customers that meet the specification rule or rules. The CRM system 102 identifies those customers qualifying for the targeted supplemental information and transmits the results back to the billing system processor 201, step 311. Linking the billing system 101 with the CRM system 102 is a particularly efficient manner in which to identify customers for receipt of targeted supplemental information. However, selection of those customers meeting selection rule qualifications does not necessarily have to be performed by the CRM system 102. Other sources of customer information could be utilized. Furthermore, at step 309, multiple sources of information could be queried to provide information. In such a case, the processor 201 assembles received results. For example, two distinct CRM systems could each be queried, or the CRM system 102 and an information source other than a CRM system could each be queried.

At step 312 the processor 201 selects a customer for whom to generate a bill or statement. This includes retrieving billing data associated with that customer from the storage device 202. Next, the processor 201 determines if that customer qualifies for presentation of one or more items of targeted supplemental information, step 315. If not, operations continue with step 325. If so, the processor next determines if the customer qualifies for presentation of two or more items of targeted supplemental information, step 318. If not, operations continue with step 318. At step 319, the single targeted supplemental information for which the customer qualifies is retrieved from the storage device 202. Thereafter, operations continue as depicted in step 325 and described below.

If the customer qualifies for presentation of two or more items of targeted supplemental information, at step 320 the processor 201 determines, by accessing information stored in the storage device 202, the targeted supplemental information item having highest priority. Each item of targeted supplemental information is ranked in the order of priority by the biller. That is, the biller orders the targeted supplemental information in order of importance to the biller. This determination is made at the biller's discretion. At step 320, the targeted supplemental information having priority over other targeted supplemental information is retrieved from the storage device 202. Discussion of presentment of multiple items of targeted supplemental information is discussed further below. That discussion is applicable to this discussion.

At step 325 the processor generates a bill or statement for the customer based upon that customer's billing data and any identified targeted supplemental billing information. This first embodiment is especially advantageous in preparing bills or statements for paper presentment. It will be recognized that supplemental billing information could be printed upon the bill, or be printed upon separate paper utilizing printer 103. Furthermore, it will be appreciated that, in accordance with this first embodiment of the invention, an electronic bill or statement could also be generated. In such a case, the bill is electronically presented to the customer via the optional communication interface 104. The optional communications interface is also usable to transmit generated billing information to bill aggregators. Preferred embodiments directed exclusively to electronic bill or statement presentment with targeted supplemental information in accordance with the present invention are described below.

Second Embodiment:

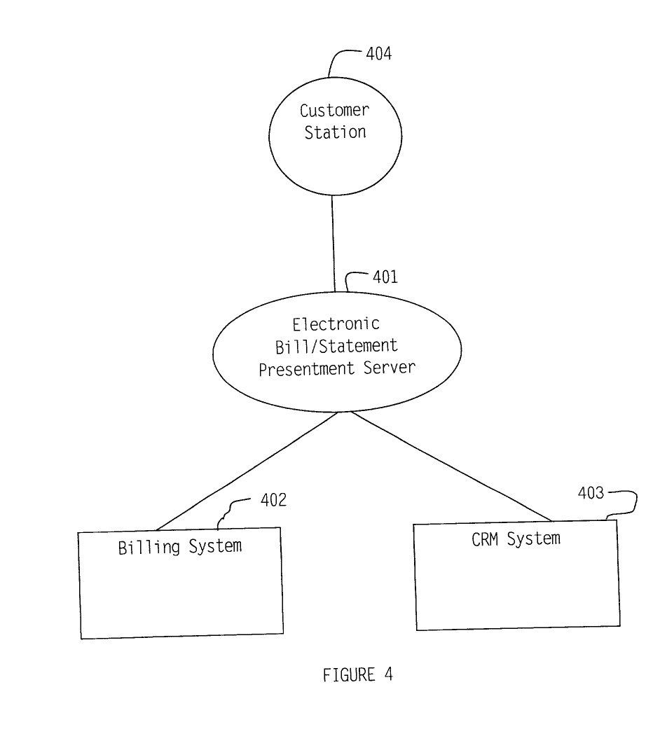

In this embodiment, presentation of targeted supplemental information is determined at the time a bill or statement is electronically presented to a customer. In this manner, a decision as to presentation of targeted supplemental information is made based upon the most up to date customer related information available from a CRM system. Of course, as above, customer related information could be obtained from another type source. FIG. 4 depicts an electronic bill and statement presentment server 401 in communication with a billing system 402, a CRM system 403, and a customer station 404. The communications with the electronic bill and statement presentment server 401 and any one of the other components can be made via any communication channel capable of transmitting data. Preferably, communications between the electronic bill and statement presentment server 401 and the customer station 404 are made via the Internet, though they could be made via other channels. The electronic bill and statement presentment server 401, in this preferred embodiment, is associated with a biller. The electronic bill and statement presentment server 401 stores selection rules and supplemental information or links to supplemental information. The billing system 402 and the CRM system 403 are also associated with the biller. The billing system 402 generates and stores billing information. As discussed above, the CRM system 403 stores information associated with a biller's customer base. This information can be any type information.

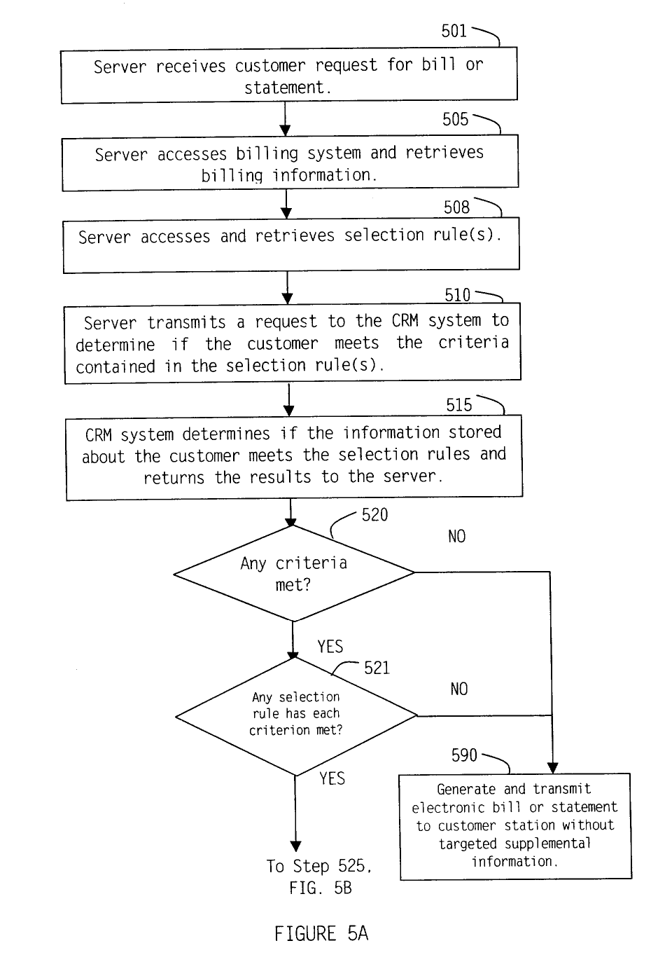

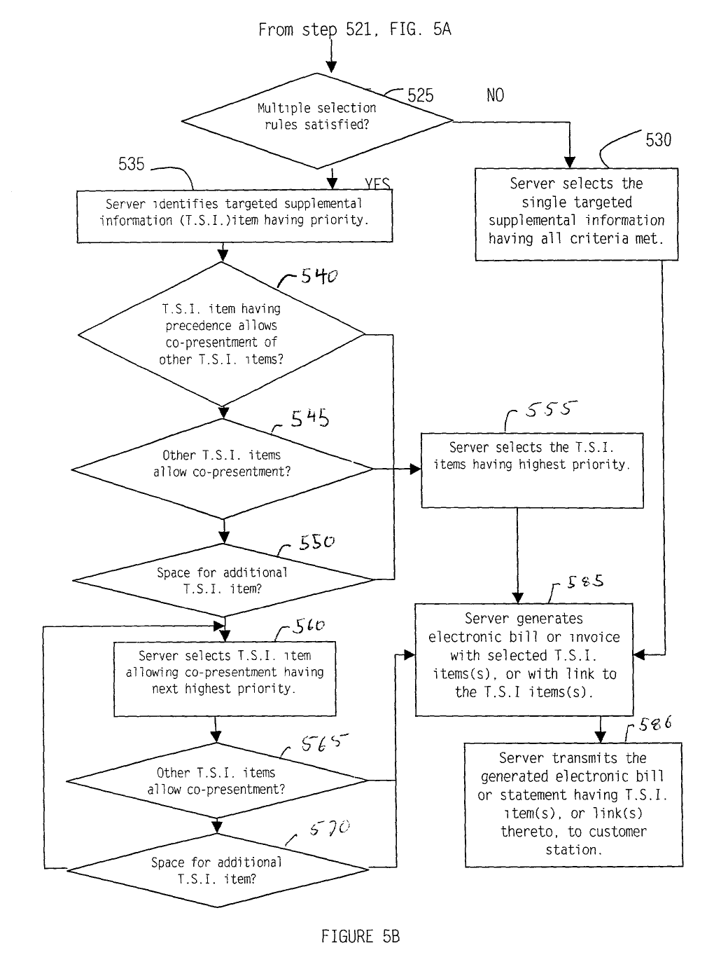

FIGS. 5A-5B depict operations to present targeted supplemental information with billing information via electronic presentment in response to a customer's request for a bill or statement. A customer request for a bill or statement could be preceded by a notice of bill or statement availability. At step 501 the electronic bill and statement presentment server 401 receives a request from the customer station 404 to electronically receive a customer's bill or statement. Preferably, this request is received via a World Wide Web interface, though it could be received via e-mail or some other form of electronic messaging. The electronic bill and statement presentment server 401 accesses the billing system 402 and retrieves billing information for the customer, step 505. This retrieved billing information could be formatted for presentation by the billing system 401, or could be unformatted billing information. The operations depicted at step 505 and described above could be performed independent from receipt of a customer request for a bill or statement. For example, billing information could be retrieved and stored prior to receipt of a request for a bill or statement. Also, billing information could be pushed from the billing system to server 401. That is, the server 401, in such a case, does not request billing information and does not access the billing system to retrieve billing information.

At step 508 the electronic bill and statement presentment server 401 accesses and retrieves the stored selection rule or rules. The selection rules are established by the biller and can be changed by the biller at any time. The present invention enables a biller to utilize the varied information stored in a CRM system to specifically define those customers who are to receive targeted supplemental information. Thus, a biller can easily adapt selection rules to comport with business needs and goals. While, according to this embodiment, the selection rules are stored at the electronic bill and statement presentment server 401, they could be stored elsewhere. The electronic bill and statement presentment server 401 then transmits a request to the CRM system 403 to determine if the customer meets the criteria contained in the selection rule or rules, step 510. That is, the electronic bill and statement presentment server 401 extracts the criteria from the selection rules and requests the CRM system 403 to identify those criteria satisfied by the customer.

The CRM system 403 then determines if the information stored associated with the customer meets the criteria of the selection rule or rules and returns the results of the determination, step 515. If a selection rule contains only a single criterion, the returned results for that criterion is simply a positive or negative determination. If a selection rule contains multiple criteria, the returned results for that selection rule are individual determinations for each of the multiple criteria. Alternatively, if multiple selection rules exist, individual requests to determine if the customer meets criteria contained in each selection rule could be transmitted to the CRM system 403.

At step 520 the electronic bill and statement presentment server 401 determines if the returned results indicate that any criteria are met. If not, operates continue with step 590. If so, the electronic bill and statement presentment server 401 then determines if each criterion for any one selection rule are met, step 521. It will be understood that this determination is made for selection rules having a single criterion as well as for selection rules having multiple criteria. If no selection rule has each of its criterion satisfied, operations continue with step 590. At step 590, an electronic bill or statement is generated for electronic transmission and then is transmitted to the customer station 404 without any targeted supplemental information. Of course, other, general, supplemental information could be electronically presented. Generation for transmission can include formatting billing data if necessary. The electronic bill or statement is preferably presented as a Web page, though it could be presented via an e-mail message or some other type of electronic message.

The electronic bill and statement presentment server 401, if the determination of step 521 is positive, determines if multiple selection rules are satisfied, step 525. If not, at step 530, the electronic bill and statement presentment server 401 selects the single targeted supplemental information having its criteria met. Operations continue with step 585.

If the customer qualifies for presentation of two or more items of targeted supplemental information, at step 535 the electronic bill and statement presentment server 401 identifies, by accessing information stored in association with the selection rules, the targeted supplemental information having highest priority, as discussed above. According to this embodiment of the present invention, multiple items of targeted supplemental information can be presented together. At step 540 the electronic bill and statement presentment server 401 determines if the information stored in association with the selection rules indicates that the targeted supplemental information (T.S.I.) item identified at step 535 can be presented at along with other T.S.I. items. This determination is made by the biller. For example, the biller may wish that the customer's attention from a certain T.S.I. item not be diverted by another T.S.I. item. If the stored information indicates that no other T.S.I. can be co-presented with the identified T.S.I. item, operations continue with step 555, discussed further below. If the determination is that other T.S.I. items can be presented with the identified T.S.I. item, operations continue with step 545. At this step the electronic bill and statement presentment server 401 determines if the information stored in association with the selection rules indicates that any of the other T.S.I. items associated with the satisfied selection rules allow co-presentment. If not, operations continue with step 555. If so, operations continue with step 550.

For bills presented electronically, a limited amount of space exists in which to present billing information alongside supplemental information on the same screen. The present invention allows this limited space to be used as efficiently as possible. At step 550 the electronic bill and statement server determines if space will be available on the generated bill for another T.S.I. item. This determination is based upon the total number of T.S.I. items already selected for inclusion in the generated bill, and on information indicating the respective sizes of individual T.S.I. items. This size information is preferably stored in association with the selection rules, though a size of a T.S.I. item could be calculated on an as-needed basis. If space is not available, operations continue with step 555. If space is available, operations continue with step 560. It should be noted that the processing described above is also applicable to generation of paper bills upon which supplemental information is printed.

At step 555, the electronic bill and statement presentment server 401 selects the identified targeted supplemental information item having the highest priority for inclusion with the generated bill. Operations then continue with step 585, to be discussed below.

At step 560, if it is determined that space is available for another T.S.I. item, the electronic bill and statement presentment server 401 identifies, from the remaining the T.S.I. items having all criteria met and allowing co-presentment, the T.S.I. item having the highest priority. Then, the server 401 determines if other T.S.I. items, having their criteria met, exist, step 565. If not, operations continue with step 585. If so, once again, at step 570, the server 401 determines if additional space exists. If space exits, operations continue with step 560. This process continues until either no other eligible T.S.I. items exist or no more space exists. When the determinations of either step 565 or step 570 is negative, operations continue with step 585.

At step 585 the processor generates a bill or statement for the customer based upon that customer's billing data and the selected supplemental billing information item or items. Generation of the bill or statement could include formatting one or both of the billing data or supplemental information if necessary. The targeted supplemental information could be presented such that it is presented along with the bill or statement. Or, the targeted supplemental information could be presented as one or more links to such information. In such a case, presentation of the targeted supplemental information would be separate from that of the bill or statement. Finally, at step 586, the generated bill or statement containing the targeted supplemental information item(s), or link(s) thereto, is transmitted to the customer station 404 by the electronic bill and statement presentation server 401. As in step 590, this transmission is preferably via the World Wide Web, though it could be via e-mail or another type messaging protocol.

Additional Embodiments

It will be recognized that the electronic bill presentment server 401 could be operated by a bill aggregator. The present invention includes several alternatives. In a first alternative, only the selection rules and supplemental information, or links thereto, are provided to the server 401. The electronic bill and statement presentment server 401 accesses the biller's billing system 402 and CRM system 403 to select and electronically present billing information and targeted supplemental information after a customer request billing information, much as described above.

In a second alternative, the biller also supplies billing data to the electronic bill and statement presentment server 401. The transmission of billing data to the electronic bill and statement presentment server 401 is made independent of a customer's request for billing information. The server 401, in this alternative, must still request the biller's CRM system to make the above-described criteria determinations.

In a third alternative, the selection rules and supplemental information, or links thereto, are not supplied to the electronic bill presentment server 401 operated by a bill aggregator, while the billing data is. In this alternative, the processing to determine receipt of targeted supplemental information is performed by the biller, not the bill aggregator. Upon receipt of request from a customer for billing information by the server 401, the information identifying the customer is passed from the server 401 to the biller. The biller then performs the operations depicted in steps 508 through 530 or 555. Upon selection of targeted supplemental information by the biller, the targeted supplemental information, or link or links thereto, is transmitted to the electronic bill and statement presentment server 401. The electronic bill and statement present server 401 then generates a bill or statement, with the targeted supplemental information, and transmits it to the customer station.

In yet fourth alternative, the electronic bill and statement presentment server 401 retrieves billing data from the biller's billing system as requested by a customer, and, as in the third alternative, the biller performs the processing to determine receipt of targeted supplemental information. In a fifth alternative, the biller provides to the electronic bill and statement presentment server 401 only summary bill data. The server 401 formulates a summary bill and transmits it to the biller station. The summary bill includes links to detailed billing information. This link takes the customer to a site controlled by the biller, not the bill aggregator. At this juncture, the operations depicted in step 501 through step 586 are performed by the biller to present detailed billing information along with targeted supplemental information.

It will also be recognized by those skilled in the art that, while the invention has been described above in terms of one or more preferred embodiments, it is not limited thereto. Various features and aspects of the above-described invention may be used individually or jointly. Further, although the invention has been described in the context of its implementation in a particular environment and for particular purposes, e.g. presenting targeted, customer-specific supplemental information to customers, those skilled in the art will recognize that its usefulness is not limited thereto and that the present invention can be beneficially utilized in any number of environments and implementations. Accordingly, the claims set forth below should be construed in view of the full breadth and spirit of the invention as disclosed herein.

We claim:

1. A method for presenting customer-specific supplemental information with billing information, comprising:
receiving billing information associated with a customer of a biller;
determining if the customer qualifies for presentment of a supplemental information item based upon qualification information other than the received billing information, historical billing information associated with the customer, or credit information associated with the customer;
generating a bill presentation; and
presenting the generated bill presentation to the customer;
wherein, if the customer is determined to qualify for presentment of the supplemental information item, the generated bill presentation includes the received billing information and the supplemental information item; and
wherein, if the customer is determined not to qualify for presentment of the supplemental information item, the generated bill presentation includes the received billing information and excludes the supplemental information item.

2. The method of claim 1, wherein the supplemental information item is one of an advertisement, an upsell offer or a cross-sell offer.

3. The method of claim 1, wherein the determination is based upon at least one of 1) a relationship between the customer and the biller, and 2) prior customer behavior.

4. The method of claim 1, wherein:
the generated bill is an electronic bill presentation; and
the electronic bill is presented via a network.

5. The method of claim 1, wherein determining if the customer qualifies for presentment of the supplemental information item includes:
transmitting a request to a customer relationship management system to determine if the customer qualifies for presentment of the supplemental information item; and
receiving a response from the customer relationship management system indicating one of 1) that the customer qualifies for presentment of the supplemental information item, or 2) that the customer does not qualify for presentment of the supplemental information item.

6. The method of claim 5, wherein:
the billing information is received from the biller by a bill aggregator;
the customer relationship management system is maintained by the biller; and
the generated bill presentation is presented by the bill aggregator.

7. The method of claim 1, wherein the customer is a first customer, further comprising:
receiving information indicating a customer response to the presented supplemental information item;
modifying the qualification information based on the received customer response information;
receiving billing information associated with a second customer of the biller;
determining if the second customer qualifies for presentment of the supplemental information item based upon the modified information;
generating another bill presentation; and
presenting the other generated bill presentation;
wherein, if the second customer is determined to qualify for presentment of the supplemental information item, the other generated bill presentation includes the received billing information associated with the second customer and the supplemental information item; and
wherein, if the second customer is determined not to qualify for presentment of the supplemental information item, the other generated bill presentation includes the billing information associated with the second customer and excludes the supplemental information item.

8. A method for presenting customer-specific supplemental information with billing information, comprising:
receiving billing information associated with a customer of a biller;
determining if the customer qualifies for presentment of a first supplemental information item;
determining if the customer qualifies for presentment of a second supplemental information item;
generating a bill presentation; and
presenting the generated bill presentation to the customer;
wherein, each determination is based upon qualification information other than the received billing information, historical billing information associated with the customer, or credit information associated with the customer;
wherein, if the customer is determined to qualify for presentment of the first supplemental information item and not the second supplemental information item, the generated bill presentation includes the received billing information and the first supplemental information item and excludes the second supplemental information item;
wherein, if the customer is determined to qualify for presentment of the second supplemental information item and not the first supplemental information item, the generated bill presentation includes the received billing information and the second supplemental information item and excludes the first supplemental information item; and
wherein, if the customer is determined not to qualify for presentment of the first and the second supplemental information items, the generated bill presentation includes the received billing information and excludes the first and the second supplemental information items.

9. The method of claim 8, wherein:
the first supplemental information item has a first priority;
the second supplemental information item has a second priority different than the first priority; and
if the customer is determined to qualify for presentment of the first and the second supplemental information items, the generated bill presentation includes the received billing information and the one of the first and the second supplemental information items having a highest priority.

10. The method of claim 8, wherein:
if the customer is determined to qualify for presentment of the first and the second supplemental information items, the generated bill presentation includes the received billing information, the first supplemental information item, and the second supplemental information item.

11. The method of claim 8, wherein the first supplemental information item has a first priority, the second supplemental information item has a second priority different than the first priority, further comprising:
determining if the first and the second supplemental information items can be presented together;
wherein, if the customer is determined to qualify for presentment of the first and the second supplemental information items and if the first and second supplemental information items are determined to be presentable together, the generated bill presentation includes the received billing information, the first supplemental information item, and the second supplemental information item; and
wherein, if the customer is determined to qualify for presentment of the first and the second supplemental information items and if the first and second supplemental information items are determined not to be presentable together, the generated bill presentation includes the received billing information and the one of the first and the second supplemental information items having a highest priority.

12. The method of claim 11, wherein the determination of whether the first and second supplemental information items can be presented together is based upon at least one of 1) availability of space to present both the first and the second supplemental information items, 2) stored information indicating whether the first supplemental information item can be presented with another supplemental information item, and 3) stored information indicating whether the second supplemental information item can be presented with another supplemental information item.

13. A system for presenting customer-specific supplemental information with billing information, comprising:
a first processor configured to transmit billing information associated with a customer of a biller; and
a second processor configured to 1) receive the transmitted billing information, 2) determine if the customer qualifies for presentment of a supplemental information item based upon qualification information other than the received billing information, historical billing information associated with the customer, or credit information associated with the customer, 3) generate a bill presentation, and 4) present the generated bill presentation;
wherein, if the customer is determined to qualify for presentment of the supplemental information item, the generated bill presentation includes the received billing information and the supplemental information item; and
wherein, if the customer is determined not to qualify for presentment of the supplemental information item, the generated bill presentation includes the received billing information and excludes the supplemental information item.

14. The system of claim 13, wherein the supplemental information item is one of an advertisement, an upsell offer, or a cross-sell offer.

15. The system of claim 13, wherein the determination is based upon at least one of 1) a relationship between the customer and the biller, and 2) prior customer behavior.

16. The system of claim 13, wherein:
the generated bill presentment is an electronic bill; and
the second processor is further configured to present the generated electronic bill via a network.

17. The system of claim 13, further comprising:
a customer relationship management processor configured to process information associated with the customer;
wherein the second processor is further configured to, in determining if the customer qualifies for presentment of the supplemental information item, transmit a request to the customer relationship management system to determine if the customer qualifies for presentment of the supplemental information item and receive a response from the customer relationship management system indicating one of 1) that the customer qualifies for presentment of the supplemental information item, or 2) that the customer does not qualify for presentment of the supplemental information item.

18. The system of claim 17, wherein:
the second processor is associated with a bill aggregator;
the first processor is associated with the biller; and
the customer relationship management processor is associated with the biller.

19. The billing apparatus of claim 13, wherein:
the customer is a first customer; and
the second processor is further configured to 1) receive information indicating a customer response to the presented supplemental information item, 2) modify the qualification information based on the received customer response information, 3) receive billing information associated with a second customer of the biller, 4) determine if the second customer qualifies for presentment of the supplemental information item based upon the modified information, 5) generate another bill presentation, and 6) present the generated bill presentation to the second customer;
wherein, if the second customer is determined to qualify for presentment of the supplemental information item, the other generated bill presentation includes the received billing information associated with the second customer and the supplemental information item; and
wherein, if the second customer is determined not to qualify for presentment of the supplemental information item, the other generated bill presentation includes the billing information associated with the second customer and excludes the supplemental information item.

20. A system for presenting customer-specific supplemental information with billing information, comprising:
a first processor configured to transmit billing information associated with a customer of a biller; and
a second processor configured to 1) receive the transmitted billing information, 2) determine if the customer qualifies for presentment of a first supplemental information item, 3) determine if the customer qualifies for presentment of a second supplemental information item, 4) generate a bill presentation, and 5) present the generated bill presentation;
wherein the second processor is further configured to make each determination based upon qualification information other than the received billing information, historical billing information associated with the customer, or credit information associated with the customer;
wherein, if the customer is determined to qualify for presentment of the first supplemental information item and not the second supplemental information item, the generated bill presentation includes the received billing information and the first supplemental information item and excludes the second supplemental information item;
wherein, if the customer is determined to qualify for presentment of the second supplemental information item and not the first supplemental information item, the generated bill presentation includes the received billing information and the second supplemental information item and excludes the first supplemental information item; and
wherein, if the customer is determined not to qualify for presentment of the first and the second supplemental information items, the generated bill presentation includes the received billing information and excludes the first and the second supplemental information items.

21. The method of claim 20, wherein:
the first supplemental information item has a first priority;
the second supplemental information item has a second priority different than the first priority; and
if the customer is determined to qualify for presentment of the first and the second supplemental information items, the generated bill presentation includes the received billing information and the one of the first and the second supplemental information items having a highest priority.

22. The method of claim 20, wherein:
if the customer is determined to qualify for presentment of the first and the second supplemental information items, the generated bill presentation includes the received billing information, the first supplemental information item, and the second supplemental information item.

23. The method of claim 20, wherein:
the first supplemental information item has a first priority; the second supplemental information item has a second priority different than the first priority;
the second processor is further configured to determine if the first and the second supplemental information items can be presented together;
if the customer is determined to qualify for presentment of the first and the second supplemental information items and if the first and second supplemental information items are determined to be presentable together, the generated bill presentation includes the received billing information, the first supplemental information item, and the second supplemental information item; and
if the customer is determined to qualify for presentment of the first and the second supplemental information items and if the first and second supplemental information items are determined not to be presentable together, the generated bill presentation includes the received billing information, and the one of the first and the second supplemental information items having a highest priority.

24. The method of claim 23, wherein the determination of whether the first and second supplemental information items can be presented together is based upon at least one of 1) availability of space to present both the first and the second supplemental information items, 2) stored information indicating whether the first supplemental information item can be presented with another supplemental information item, and 3) stored information indicating whether the second supplemental information item can be presented with another supplemental information item.

25. An article of manufacture for presenting customer-specific supplemental information with billing information comprising:
a computer readable medium; and
computer programming stored on the medium;
wherein the stored computer programming is configured to be readable from the computer readable medium by a computer to thereby cause the computer to operate so as to:
receive billing information associated with a customer of a biller;
determine if the customer qualifies for presentment of a supplemental information item based upon qualification information other than the received billing information, historical billing information associated with the customer, or credit information associated with the customer;
if the customer is determined to qualify for presentment of the supplemental information item, generate a bill presentation including the received billing information and the supplemental information item;
if the customer is determined not to qualify for presentment of the supplemental information item, generate a bill presentation including the received billing information and excluding the supplemental information item; and
cause the generated bill presentation to be presented to the customer.
